(19) United States
(12) Patent Application Publication
(10) Pub. No.: US 2019/0087724 A1
(43) Pub. Date: Mar. 21, 2019

(54) METHOD OF OPERATING KNOWLEDGEBASE AND SERVER USING THE SAME

(71) Applicant: FOUNDATION OF SOONGSIL UNIVERSITY INDUSTRY COOPERATION, Seoul (KR)

(72) Inventors: Young Tack PARK, Seoul (KR); Wan Gon LEE, Seoul (KR); Batselem JAGVARAL, Seoul (KR); Hyun Young CHOI, Seoul (KR); Ji Houn HONG, Gwacheonsi (KR)

(21) Appl. No.: 15/856,463

(22) Filed: Dec. 28, 2017

(30) Foreign Application Priority Data
Sep. 21, 2017 (KR) 10-2017-0121840

(51) Int. Cl. G06N 3/08; G06N 5/02

(52) U.S. Cl. CPC G06N 3/08; G06N 5/02

(57) ABSTRACT

Disclosed are a method of operating a knowledgebase and a server using the same. The method of operating a knowledgebase may include: (a) receiving triple data sets as input; (b) forming at least one data cluster set by classifying the triple data sets according to relation based on semantic information of the knowledgebase; and (c) learning each relation model by inputting the data cluster set into a neural tensor network.

### CROSS-REFERENCE TO RELATED APPLICATIONS

This application claims the benefit of Korean Patent Application No. 10-2017-0121840, filed with the Korean Intellectual Property Office on Sep. 21, 2017, the disclosure of which is incorporated herein by reference in its entirety.

### BACKGROUND

### 1. Technical Field

The present invention relates to a method of operating a knowledgebase and a server using the same which can partially complete an incomplete knowledgebase.

### 2. Description of the Related Art

An NTN (neural tensor network) provides a method of deducing the relation between two entities as proposed by Socher. A method was proposed which utilizes a linear artificial neural network involving two tensor layers with entities embedded as multi-dimensional vectors, as shown in FIG. 1, with the result providing higher performance compared to existing relation model learning methods. By a method of adopting dual tensor layers instead of neural network layers to incorporate all relationships between entities, a greater improvement in performance was achieved.

However, in existing methods, the learning may be performed for the entire knowledgebase, so that the complexity of the calculations may be very high, and in cases where the relation learning takes place for large-scale data, a considerably long time may be required. Also, since there is no method that deals with processing a knowledgebase that entails a continuous addition of new data, the process of learning may have to be performed repeatedly for the entire data.

### SUMMARY OF THE INVENTION

An aspect of the invention is to provide a method of operating a knowledgebase and a server using the same which can partially complete an incomplete knowledgebase.

Also, an aspect of the invention is to provide a method of operating a knowledgebase and a server using the same which can reduce operation time in completing the knowledge of an incomplete knowledgebase and which can enable efficient processing for a dynamically changing knowledgebase.

Also, an aspect of the invention is to provide a method of operating a knowledgebase and a server using the same which can conduct the learning by partially extracting the required data without using the entire knowledgebase.

One aspect of the invention provides a method of operating a knowledgebase that can partially complete an incomplete knowledgebase.

An embodiment of the invention provides a method of operating a knowledgebase that includes: (a) receiving triple data sets as input; (b) forming at least one data cluster set by classifying the triple data sets according to relation based on semantic information of the knowledgebase; and (c) learning each relation model by inputting the data cluster set into a neural tensor network.

Step (c) can include embedding an entity vector in a vector space after deriving the entity vector for entities included in a subject position, a predicate position, and an object position of a triple data set included in the data cluster set; and learning each relation by applying the entity vector to a neural tensor network.

The step of forming the data cluster set can include: grouping similar relations into cluster groups based on the semantic information; and forming the data cluster set by classifying the triple data sets according to similar relations included in each of the cluster groups.

Another embodiment of the invention provides a method of operating a knowledgebase that includes: (a) receiving input of a target relation for knowledge which is to be updated in the knowledgebase; (b) extracting candidate relation information regarding candidate relations similar to the target relation based on semantic information of the knowledgebase; and (c) selecting a data cluster set corresponding to the candidate relation information and applying the selected data cluster set to a neural tensor network to learn a relation model according to the candidate relation information.

Step (b) can include: selecting relations similar to the target relation by using the semantic information, which includes schema information, of the knowledgebase; deriving similarities with the target relation and with the selected similar relations; and extracting relations having similarities greater than or equal to a threshold value from among the selected similar relations as candidate relation information, where the candidate relation information can include the target relation.

Deriving the similarities with the target relation and with the selected similar relations can include: deriving the similarities by dividing the number of triple data sets that share a subject and an object, from among triple data sets using the target relation and an observed relation for which the similarity is being derived, by the minimum value between the number of triple data sets including the observed relation and the number of triple data sets including the target relation.

Step (c) can include extracting triple data sets having relations included in the candidate relation information as a data cluster set and converting the triple data sets included in the data cluster set into triple sequences and then into entity vectors; and learning a relation model corresponding to the candidate relation information by applying the entity vectors into the neural tensor network.

Another aspect of the invention provides an apparatus that can partially complete an incomplete knowledgebase.

An embodiment of the invention can provide a server configured to operate a knowledgebase, where the server includes: an input unit configured to receive input of triple data sets; an extraction unit configured to form at least one data cluster set by classifying the triple data sets according to relation based on semantic information of the knowledgebase; and a learning unit configured to learn each relation model by inputting the data cluster set into a neural tensor network.

Another embodiment of the invention can provide a server configured to operate a knowledgebase, where the server includes: an input unit configured to receive input of a target relation for knowledge which is to be updated in the knowledgebase; an extraction unit configured to extract candidate relation information regarding candidate relations similar to the target relation based on semantic information of the knowledgebase; and a learning unit configured to select a data cluster set corresponding to the candidate relation information and apply the selected data cluster set to a neural tensor network to learn a relation model according to the candidate relation information.

With a method of operating a knowledgebase and a server using the method according to an embodiment of the invention, it is possible to partially complete an incomplete knowledgebase.

Also, an embodiment of the invention can reduce operation time in completing the knowledge of an incomplete knowledgebase and can enable efficient processing for a dynamically changing knowledgebase.

Also, an embodiment of the invention can conduct the learning by partially extracting only the required data without using the entire knowledgebase.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 illustrates a neural tensor layer according to the related art.

FIG. 2 is a flow diagram illustrating a method of operating a knowledgebase according to an embodiment of the invention.

FIG. 3 is a diagram for explaining a triple data set according to an embodiment of the invention.

FIG. 4 shows an example of a triple set according to an embodiment of the invention converted into a sentence form.

FIG. 5 shows an example of training data according to an embodiment of the invention.

FIG. 6 is a flow diagram illustrating a method of updating a knowledgebase according to an embodiment of the invention.

FIG. 7 is a diagram for explaining a method of extracting candidate relation information according to an embodiment of the invention.

FIG. 8 is a diagram for explaining the similarity between two relations according to an embodiment of the invention.

FIG. 9 is a diagram for explaining a subset expansion according to an embodiment of the invention.

FIG. 10 is a diagram conceptually illustrating the composition of a server operating a knowledgebase according to an embodiment of the invention.

FIG. 11 is a diagram for explaining a method of learning by extracting subsets from a knowledgebase according to an embodiment of the invention.

### DETAILED DESCRIPTION OF THE INVENTION

In the present specification, an expression used in the singular encompasses the expression of the plural, unless it has a clearly different meaning in the context. In the present specification, terms such as “comprising” or “including,” etc., should not be interpreted as meaning that all of the elements or steps are necessarily included. That is, some of the elements or steps may not be included, while other additional elements or steps may be further included. Also, terms such as “unit” or “module,” etc., refers to a unit subject that processes at least one function or action, and such unit subject can be implemented as hardware or software or a combination of hardware and software.

Certain embodiments of the present invention are described below in more detail with reference to the accompanying drawings.

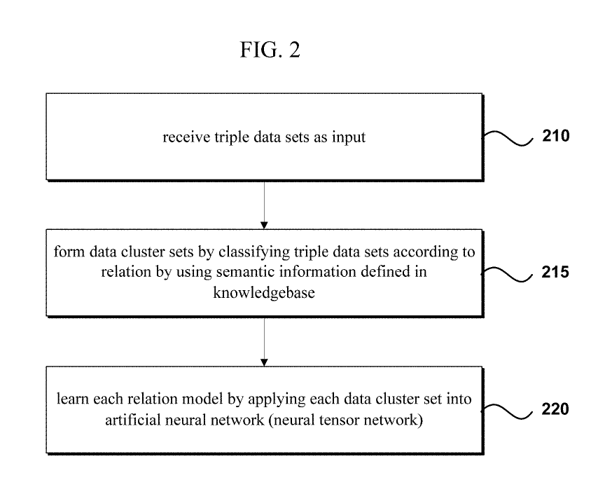

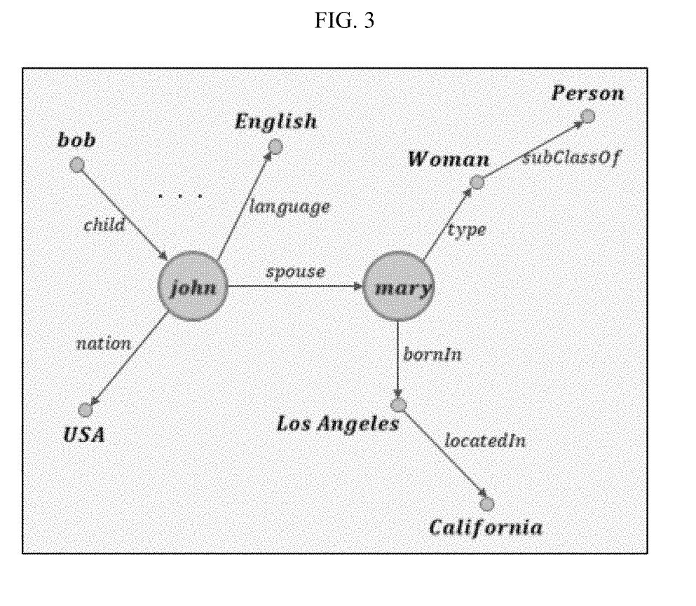

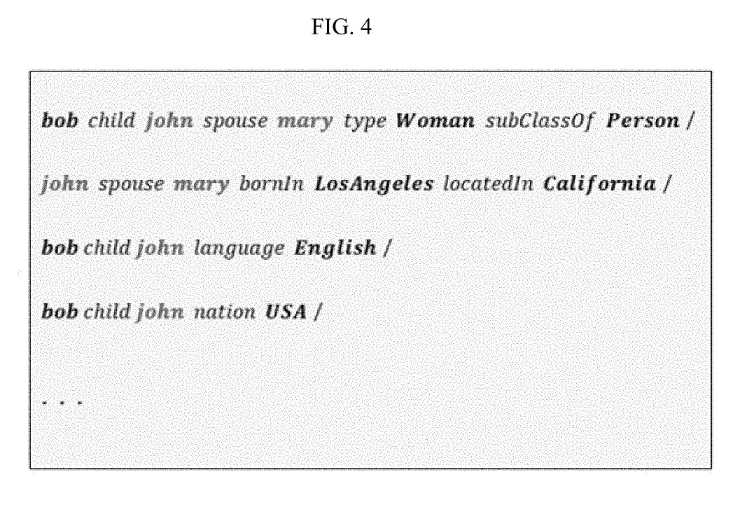

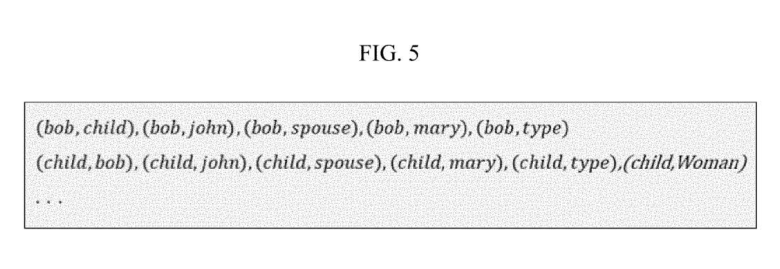

FIG. 2 is a flow diagram illustrating a method of operating a knowledgebase according to an embodiment of the invention, FIG. 3 is a diagram for explaining a triple data set according to an embodiment of the invention, FIG. 4 shows an example of a triple set according to an embodiment of the invention converted into a sentence form, and FIG. 5 shows an example of training data according to an embodiment of the invention.

In step 210, a server 200 may receive triple data sets as input. A triple data set may include information on each entity as a subject and an object, with information on the relation between the subject and object included in the form of a predicate.

The format of a triple data set may be as shown below.

<Tom isSpouseOf Mary>

In the example of a triple data set shown above, the term Tom included in the subject position and the term Mary included in the object position can each represent an entity. Also, from the term isSpouseOf included in the predicate position, the relation between Tom and Mary can be understood.

In the present specification, it should be understood that an entity refers to data included in the subject or object position of a triple data set. Also, it should be understood that a relation refers to data included in the predicate position of the triple data set.

Such triple data is well known to the skilled person and as such is not described here in further detail.

In step 215, the server 200 may form data cluster sets by using the semantic information defined on the knowledgebase to classify the triple data sets according to each relation.

For example, in one embodiment of the invention, the semantic information can be defined beforehand by using RDFS, OWL, etc. Here, the semantic information can be schema information defined in RDFS or OWL and can include information on various rules. RDFS and OWL are examples of a knowledgebase that are well known to the skilled person and as such are not described here in further detail.

Although RDFS and OWL are used as examples for the sake of better understanding and easier explanation, an embodiment of the invention can obviously be applied to other known types of knowledgebases.

Also, although it is supposed that the triple data sets are classified according to relation for the sake of better understanding and easier explanation, it is also possible to group similar relations into a single cluster group and classify the triple data sets in correspondence to the cluster groups.

For better understanding and easier explanation, the similar relations grouped into a cluster group will be referred to as a relation cluster group.

Also, in the descriptions that follow, a data cluster set refers to the triple data sets classified based on similar relations according to a relation cluster.

For the sake of convenience, the sets of relation information are supposed as R1, R2, R3, . . . , Rn. Also, the relation clusters are supposed as C1, C2, . . . , Cm.

Here, it is supposed that C1 includes R1, R2, and R3 as similar relation information to form a cluster and that C2 includes R5, R8, and R9 to form a relation cluster.

The server 200 can classify those triple data sets that include any one relation of R1, R2, R3 included in C1 as a data cluster set. Therefore, the triple data sets included in a data cluster set can be understood as data sets that include any one of the similar relations included in the relation cluster.

For example, suppose C1 is the “Spouse” relation cluster. C1 can include similar relations such as “Spouse”, “Husband”, “Wife”, etc. Therefore, every triple data set that includes any one of “Spouse”, “Husband”, and “Wife” can be classified into the C1 data cluster set.

In step 220, the server 200 may learn each relation model by applying each data cluster set to an artificial neural network (more specifically, a neural tensor network). In learning the relation models through a neural tensor network, the triple data sets included in the data cluster set can be used to additionally form relations of incomplete knowledge via deduction.

To be more specific, the server 200 can convert the triple data sets included in each data cluster set into a sentence form and afterwards embed the results into an entity space by using a known algorithm such as Skip-gram, etc.

For example, suppose there exist triple data sets as shown in FIG. 3. The server 200 can convert these triple data sets into a sentence form, as illustrated in FIG. 4, and then embed each entity as a vector into a multi-dimensional vector space.

In an embodiment of the invention, the server 200 can convert the triple data sets into a sentence form as illustrated in FIG. 4 and then change the results into training data by using the Skip-gram and RDF2sentence algorithms. The server 200 can generate entity vectors from such training data by using the word2vec algorithm.

As algorithms such as Skip-gram, RDF2sentence, word2vec, etc., are well known to the skilled person, they are not described here in further detail.

One example of training data obtained using Skip-gram is shown in FIG. 5.

Each entity vector can be generated in multiple dimensions. For example, an entity vector can be generated with 100 dimensions.

The entity vectors thus generated can be embedded in a vector space.

The method employed by an embodiment of the invention may entail embedding not the triple data sets themselves but the data sets converted into entity vectors of a numerical form that are embedded into a vector space, which may then form the basis for learning the relation models.

In this way, an embodiment of the invention can provide the advantage of reducing the time required for learning the relation models.

Based on the entity vectors thus generated, the server 200 can learn each relation model by using the neural tensor network. Here, the neural tensor network is well known to the skilled person and as such is not described here in further detail.

According to an embodiment of the invention, the entity vectors can be divided into three data sets of training/dev/test. The training data may be used for the actual learning of the relation model, and the test data may be used for evaluating the performance of the learned relation model. Also, the dev data can be used to determine a threshold value for comparing the points of the new data calculated by way of the learned relation model.

The threshold value can be determined by randomly changing the subject/object of the dev data that can be supposed to be true to different values and thus generating all data corresponding to true/false.

In an embodiment of the invention, each relation model can be learned by applying two multi-dimensional entity vectors to the neural tensor network. Each relation model may calculate the point for the relation between two entities by using Equation 1.

$$g ( {e}_{1} , R , {e}_{2} ) = {u}_{R}^{T} f ( {e}_{1}^{T} {W}_{R}^{[ 1 : k ]} {e}_{2} + {V}_{R} [ \begin{matrix}{e}_{1} \\ {e}_{2}\end{matrix} ] + {b}_{R} ) \qquad [ Equation 1 ]$$

By multiplying the linear layer u^{T} to the sum of the slices of the tensor layer e₁^{T}W_{R}^{[1:k]}e₂, the standard layer

$${V}_{R} [ \begin{matrix}{e}_{1} \\ {e}_{2}\end{matrix} ] ,$$

and the bias b, a point value can be derived for the data associated with the relation R and the two entities.

Also, the cost function for each relation model according to an embodiment of the invention may be represented as Equation 2.

$$J ( Ω ) = {\sum }_{i = 1}^{N} {\sum }_{c = 1}^{C} max ( 0 , 1 - g ( {T}^{( i )} ) + g ( {T}^{( i )} ) + g ( {T}_{c}^{( i )} ) ) + λ {‖ Ω ‖}_{2}^{2} \qquad [ Equation 2 ]$$

Here, T_{c} represents corrupt data, where the entities of an actual triple data set are changed at random. A relation model can be generated by iterative learning performed such that the cost is the lowest when the C number of corrupt data sets and the point are compared for the N number of learning data sets.

The above described the procedures of establishing relation models by an initial input of multiple sets of triple data and automatic deduction by learning through a neural tensor network, with reference to FIG. 2. In the following, a description is provided on a method of updating the knowledgebase with the relation models already formed according to FIG. 2.

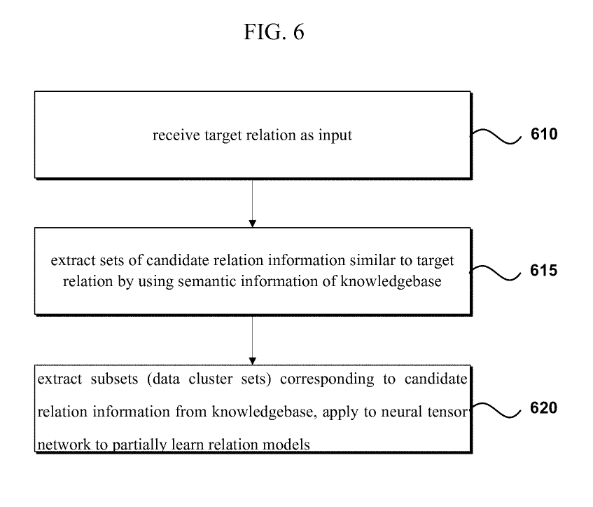

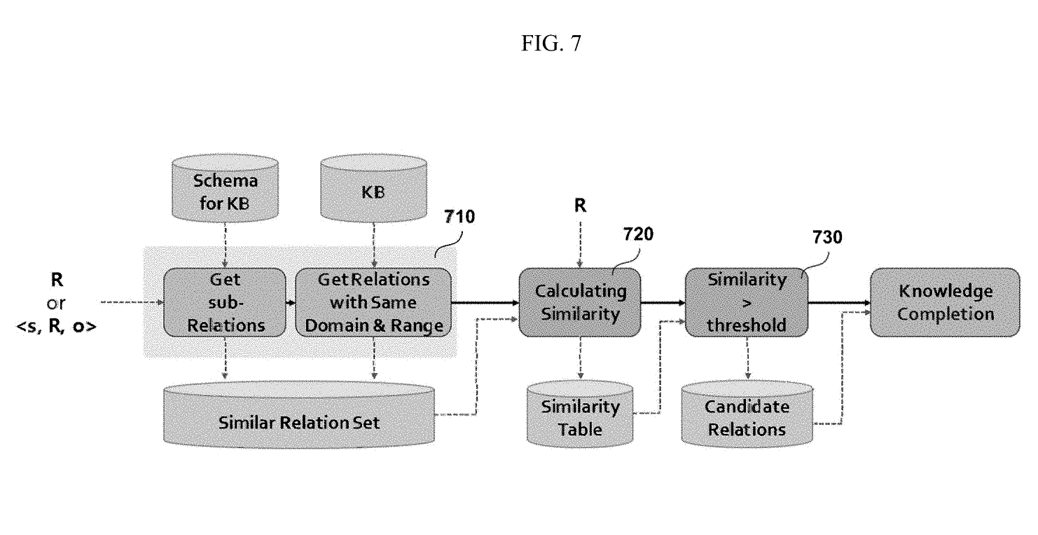

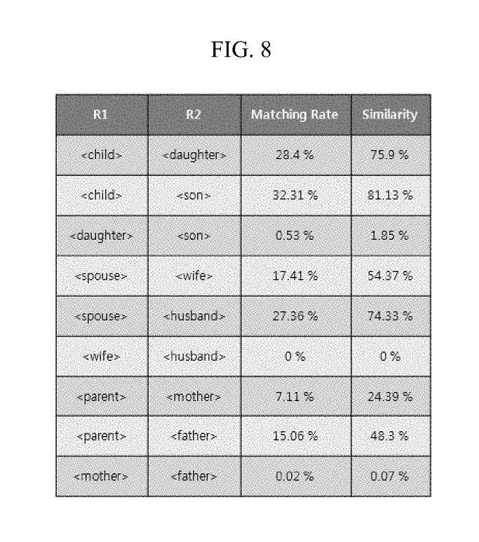

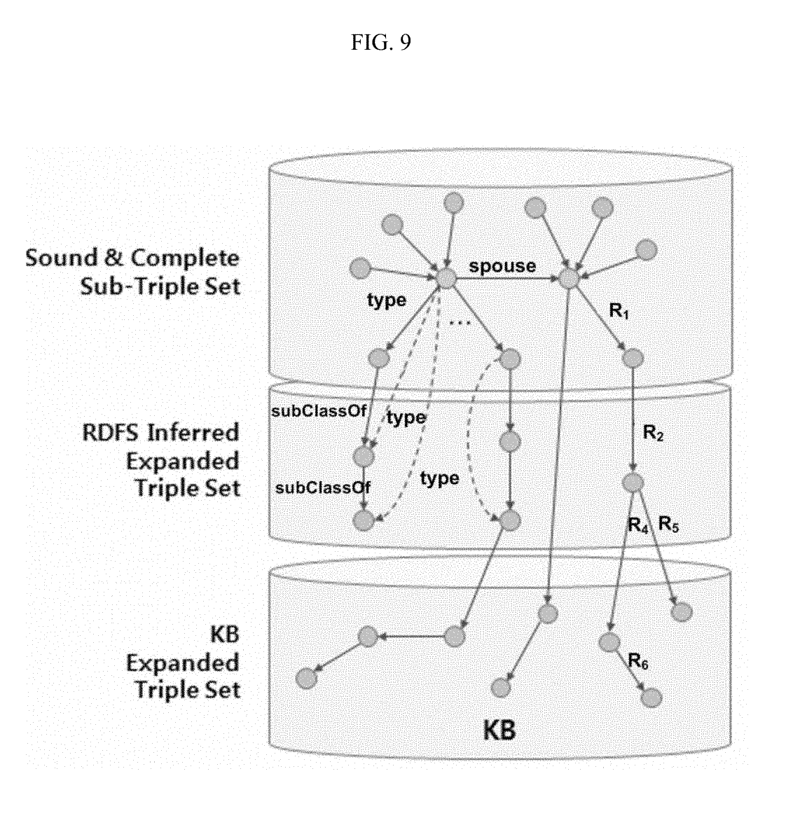

FIG. 6 is a flow diagram illustrating a method of updating a knowledgebase according to an embodiment of the invention, FIG. 7 is a diagram for explaining a method of extracting candidate relation information according to an embodiment of the invention, FIG. 8 is a diagram for explaining the similarity between two relations according to an embodiment of the invention, and FIG. 9 is a diagram for explaining a subset expansion according to an embodiment of the invention.

In step 610, the server 200 may receive input of target relation information. Here, the target relation information represents a particular relation for which an update in the knowledgebase is desired.

For example, suppose that the particular relation that is to be updated is “spouse”. In this case, the server 200 can be inputted with “spouse” as the target relation information.

In step 615, the server 200 may extract candidate relation information regarding candidate relations similar to the target relation by using the semantic information of the knowledgebase.

A more detailed description is provided below with reference to FIG. 7.

For example, the server 200 can extract subordinate relations of the target relation or choose the similar relations by utilizing semantic information such as domain, range, and inverse (710). The similar relations thus selected can be separated stored in similar relation sets.

When the similar relations are chosen thus, the server 200 may calculate the similarities between the target relation and the chosen similar relations (720).

The levels of similarity between the target relation and the chosen similar relations can be calculated by using Equation 3.

$$Similarity ( {R}_{1} , {R}_{2} ) = \frac{\vert {Π}_{{R}_{1}} ⋂ {Π}_{{R}_{1}} \vert}{min ( \vert {Π}_{{R}_{1}} \vert , \vert {Π}_{{R}_{2}} \vert )} \qquad [ Equation 3 ]$$

Here, R₁ and R₂ each represent a relation. Also, Π_{R}_{₁} represents the number of data sets that include R₁, while Π_{R}_{₂} represents the number of data sets that include R₂.

Thus, the minimum value between the number of data sets that use the target relation of Equation 1 and the number of data sets that use each similar relation can be placed in the denominator, and the number of data sets that share the subject and the object from among the data sets using the relations can be placed in the numerator, to calculate the level of similarity.

After deriving the similarity between the target relation and each of the chosen similar relations, only those whose values are greater than or equal to a threshold can be extracted as candidate relation information and used in completing the knowledge (730).

After the similarity for each relation is derived, the values can be stored in a relation similarity database, as illustrated in FIG. 8. Obviously, the relation similarity information can be stored as in FIG. 8 to be used for future updates of the knowledgebase.

In step 620, the server 200 may perform the task of completing the knowledge of the knowledgebase by using the data sets related to the candidate relation information to learn the relation model.

To be more specific, the server 200 may extract the data sets related to the candidate relation information from the knowledgebase. For example, the data cluster sets related to the candidate relation information can be selected by using cluster metadata as described above with reference to FIG. 2. Then, the data sets included in the data cluster set can be converted into a sentence form and converted into entities by using the known skip-gram algorithm as described above, entity vectors can be generated by using an algorithm such as word2vec, etc., and the entity vectors can be embedded in a vector space.

In learning the relation models, various data sets related to the target relation are necessary in order to increase the performance of the relation model learning. Therefore, in an embodiment of the invention, sets of relation information similar to the target relation can be chosen, the similarity levels can be derived to obtain sets of candidate relation information, and the data can be extracted with expansions based on each set of candidate relation information (see FIG. 9).

As set forth above, when a target relation is inputted, the server 200 can extract those relations that are similar to the target relation as candidate relation information, and can perform the learning of the relation models only for the data cluster sets associated with the candidate relation information. This can provide the advantage of improved processing performance when updating the knowledgebase.

Also, instead of learning the relation models by selecting only the data cluster set for the target relation, the learning of the relation models can entail selecting relations similar to the target relation, including the deduction of the semantic information of schema information, and extracting all sets of candidate relation information having similarity levels of a particular threshold value or higher to select data cluster sets, thereby providing the advantage of supplementing an incomplete knowledgebase.

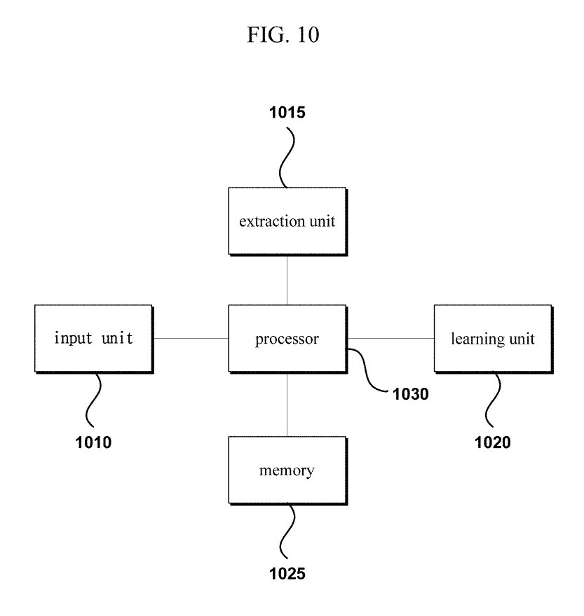

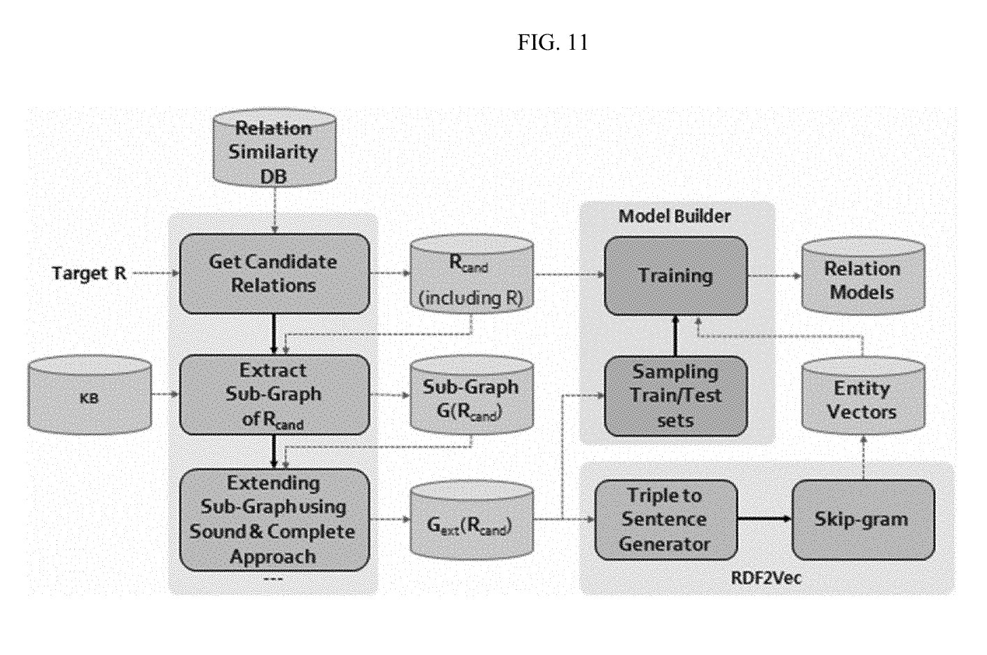

FIG. 10 is a diagram conceptually illustrating the composition of a server operating a knowledgebase according to an embodiment of the invention, and FIG. 11 is a diagram for explaining a method of learning by extracting subsets from a knowledgebase according to an embodiment of the invention.

Referring to FIG. 10, a server 200 according to an embodiment of the invention may include an input unit 1010, an extraction unit 1015, a learning unit 1020, a memory 1025, and a processor 1030.

The input unit 1010 may be a device for receiving input such as the triple data sets or the target relation, etc.

The extraction unit 1015 may be a device for extracting candidate relations similar to the triple data sets or the target relation.

For a more detailed description, consider FIG. 11.

Based on the semantic information of the knowledgebase, a particular relation included in an inputted triple data set or relations similar to the target relation can be selected.

In selecting the similar relations corresponding to the triple data set or the target relation based on semantic information, a deduction regarding the semantic information can be included to select similar relations. After deriving the similarity levels for the selected similar relations, the similar relations yielding similarities greater than or equal to a threshold can be extracted as candidate relation information.

The candidate relation information thus extracted can be stored separately in a database or stored in metadata form.

The extraction unit 1015 can extract the data cluster set corresponding to the final extracted candidate relation information and output the data cluster set to the learning unit 1020. Here, the detailed method of extracting the data cluster set corresponding to the candidate relation information is as illustrated in FIG. 11.

In the present specification, it should be understood that candidate relation information includes the target relation information.

The extraction unit 1015 can extract the candidate relation information, group (relation cluster) this into a cluster, and store this in the form of metadata. The extraction unit 1015 can extract the triple data sets that include the sets of candidate relation information and output the triple data sets to the learning unit 1020.

The learning unit 1020 may be a device for learning the relation model by using the data cluster set corresponding to the candidate relation information.

Here, the learning unit 1020 can convert the triple data sets included in the data cluster set into sentence form, convert these into entities by using skip-gram, etc., derive the entity vectors by using word2vec, and embed the entity vectors in a vector space.

Next, the learning unit 1020 can learn the entity vectors embedded in the vector space by way of an artificial neural network for each relation model.

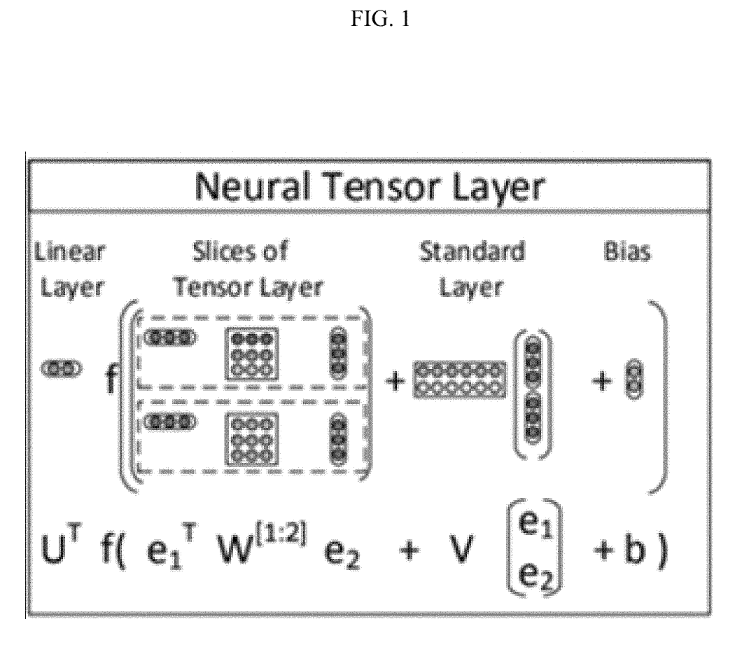

This is as already described above with reference to FIG. 1 through FIG. 9, and as such, redundant descriptions are omitted.

The memory 1025 may be a device for storing the various data and algorithms needed for performing a method of operating a knowledgebase according to an embodiment of the invention, as well as the data associated with the procedures involved.

The processor 1030 may be a means for controlling the inner components (e.g. the input unit 1010, extraction unit 1015, learning unit 1020, memory 1025, etc.) of a server 200 according to an embodiment of the invention.

The embodiments of the present invention can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc. Examples of the program of instructions may include not only machine language codes produced by a compiler but also high-level language codes that can be executed by a computer through the use of an interpreter, etc. The hardware mentioned above can be made to operate as one or more software modules that perform the actions of the embodiments of the invention, and vice versa.

While the present invention has been described above using particular examples, including specific elements, by way of limited embodiments and drawings, it is to be appreciated that these are provided merely to aid the overall understanding of the present invention, the present invention is not to be limited to the embodiments above, and various modifications and alterations can be made from the disclosures above by a person having ordinary skill in the technical field to which the present invention pertains. Therefore, the spirit of the present invention must not be limited to the embodiments described herein, and the scope of the present invention must be regarded as encompassing not only the claims set forth below, but also their equivalents and variations.

What is claimed is:

1. A method of operating a knowledgebase, the method comprising:
(a) receiving input of triple data sets;
(b) forming at least one data cluster set by classifying the triple data sets according to relation based on semantic information of the knowledgebase; and
(c) learning each relation model by inputting the data cluster set into a neural tensor network.

2. The method of operating a knowledgebase according to claim 1, wherein said step (c) comprises:
embedding an entity vector in a vector space after deriving the entity vector for entities included in a subject position, a predicate position, and an object position of a triple data set included in the data cluster set; and
learning each relation by applying the entity vector to a neural tensor network.

3. The method of operating a knowledgebase according to claim 1, wherein the forming of the data cluster set comprises:
grouping similar relations into cluster groups based on the semantic information; and
forming the at least one data cluster set by classifying the triple data sets according to similar relations included in each of the cluster groups.

4. A method of operating a knowledgebase, the method comprising:
(a) receiving input of a target relation for knowledge which is to be updated in the knowledgebase;
(b) extracting candidate relation information regarding candidate relations similar to the target relation based on semantic information of the knowledgebase; and
(c) selecting a data cluster set corresponding to the candidate relation information and applying the selected data cluster set to a neural tensor network to learn a relation model according to the candidate relation information.

5. The method of operating a knowledgebase according to claim 4, wherein said step (b) comprises:
selecting relations similar to the target relation by using the semantic information of the knowledgebase, the semantic information including schema information;
deriving similarities with the target relation and with the selected similar relations; and
extracting relations having similarities greater than or equal to a threshold value from among the selected similar relations as candidate relation information,
and wherein the candidate relation information includes the target relation.

6. The method of operating a knowledgebase according to claim 5, wherein the deriving of the similarities with the target relation and with the selected similar relations comprises:
deriving the similarities by dividing a number of triple data sets sharing a subject and an object, from among triple data sets using the target relation and an observed relation for which the similarity is being derived, by a minimum value between a number of triple data sets including the observed relation and a number of triple data sets including the target relation.

7. The method of operating a knowledgebase according to claim 5, wherein said step (c) comprises:
extracting triple data sets having relations included in the candidate relation information as a data cluster set and converting the triple data sets included in the data cluster set into triple sequences and then into entity vectors; and
learning a relation model corresponding to the candidate relation information by applying the entity vectors into the neural tensor network.

8. A computer-readable recorded medium product having recorded thereon a set of program code for performing the method of operating a knowledgebase according to claim 1.

9. A server configured to operate a knowledgebase, the server comprising:
an input unit configured to receive input of triple data sets;
an extraction unit configured to form at least one data cluster set by classifying the triple data sets according to relation based on semantic information of the knowledgebase; and
a learning unit configured to learn each relation model by inputting the data cluster set into a neural tensor network.

10. A server configured to operate a knowledgebase, the server comprising:
an input unit configured to receive input of a target relation for knowledge which is to be updated in the knowledgebase;
an extraction unit configured to extract candidate relation information regarding candidate relations similar to the target relation based on semantic information of the knowledgebase; and
a learning unit configured to select a data cluster set corresponding to the candidate relation information and apply the selected data cluster set to a neural tensor network to learn a relation model according to the candidate relation information.
